(19) United States
(12) Patent Application Publication
(10) Pub. No.: US 2017/0327658 A1
(43) Pub. Date: Nov. 16, 2017

(54) SURFACE TREATMENT PROCESS FOR OBJECTS

(71) Applicant: Sculpteo, Villejuif (FR)

(72) Inventors: Clément MOREAU, Clamart (FR); Myrtille COMTE, Maisons-Laffitte (FR)

(21) Appl. No.: 15/590,149

(22) Filed: May 9, 2017

(30) Foreign Application Priority Data
May 10, 2016 (FR) 1654150

(51) Int. Cl. C08J 7/14; B33Y 10/00; B29C 71/00; B29C 71/02; B29C 64/188

(52) U.S. Cl. CPC C08J 7/14; B29C 71/02; B29C 64/188; B33Y 10/00; B29C 71/0009; B29C 2071/022; B29K 2995/0073

(57) ABSTRACT

A process for surface treatment of an object, including the following steps: dipping the object in a solution comprising a concentrated acid or a mixture of concentrated acids, and having a pH of between 0 and 2, in order to impregnate the surface of the object, removing the object from the acid solution, heating the object at a temperature of between 140° C. and 180° C., until melting of the surface is obtained, and cooling the object. The process according to the presently disclosed embodiment applies in particular, but not exclusively, to objects resulting from additive manufacture techniques.

### CROSS REFERENCE TO RELATED APPLICATION

This application claims priority to and the benefit of French Application No. 1654150, filed on 10 May 2016, the disclosure of which is incorporated herein by reference in its entirety.

### BACKGROUND

### 1. Field

The presently disclosed embodiment relates to the field of surface treatment processes for objects, in particular for objects resulting from additive manufacture, also called “3D printing”.

The presently disclosed embodiment relates more particularly to a surface treatment process for objects, for example made of polyamide and in particular resulting from additive manufacture techniques.

### 2. Brief Description of Related Developments

Additive manufacture, also called 3D printing, makes it possible to create objects stratum-by-stratum without using moulds. It is in particular employed for the rapid production of plastic parts.

The objects thus produced have a surface that is rougher than those obtained by plastic injection moulding. In some specific cases, when they are shaped, their surface is in contact with grains of plastic powder or air rather than with a smooth mold.

This rendering is disturbing for certain applications: an object may for example be judged visually or tactilely unattractive because of this effect.

Several solutions currently exist, in particular polishing using abrasives, applying varnish/resin or else chemical or thermochemical dissolution of the surface of the object followed by resolidification.

Currently, the latter method consists in leaving the object in contact with vapours of a solvent or of a mixture of solvents and then removing it when the rendering is judged acceptable. The most widespread polymer/solvent duo is ABS (acrylonitrile butadiene styrene) treated with acetone vapours, but other combinations have been proposed.

One of the polymers employed in 3D printing, polyamide, has good overall chemical resistance, making it difficult to dissolve with vaporized solvent at ambient temperature. It is for example totally resistant to acetone. An increase in temperature can promote the process, but risks causing safety problems dependent on the nature of the solvents employed.

### SUMMARY

The presently disclosed embodiment is intended to remedy the drawbacks of the prior art by providing a process based on dipping in an acid solution and then an increase in temperature for treating objects, for example made of polyamide, in particular but not exclusively objects resulting from an additive manufacture process.

To this effect, the presently disclosed embodiment relates, in its most general sense, to a process for surface treatment of an object, comprising the following steps:
dipping said object in a solution comprising a concentrated acid or a mixture of concentrated acids, and having a pH of between 0 and 2, in order to impregnate the surface of said object;
removing said object from said acid solution;
heating said object at a temperature of between 140° C. and 180° C., until melting of the surface is obtained; and
cooling said object.

The process according to the presently disclosed embodiment has the following technical advantages:
This treatment solves the problem of the chemical resistance of polyamide: by virtue of its molecular nature, the latter is sensitive to acids (catalysed hydrolysis).
The acid-activated surface will have a lower melting point than the core of the object, thus making it possible to preserve the shape of the object during the treatment.
The melting/solidification cycle allows the surface to reorganize, smoothing out the hollows and bumps under the effect of surface tension and resulting in smoothing of the surface.
The chemical agent is in liquid form and is applied to the object at ambient temperature, which allows a certain ease in terms of setting up and reducing the risks associated with safety.

Preferably, said acid solution has a pH of between 0 and 1.

Advantageously, said acid is a mineral acid.

According to one aspect of the presently disclosed embodiment, said acid is included in the following group: sulphuric acid, nitric acid, phosphoric acid and hydrochloric acid.

Preferably, the heating of said object is carried out at a temperature of between 155° C. and 170° C.

Advantageously, said process also comprises a step of removing the surplus liquid.

According to one variant, the removing of the surplus liquid is carried out by applying a centrifugal force to said object.

According to another variant, the removing of the surplus liquid is carried out by causing said object to vibrate.

Preferably, said heating step is carried out using a forced convection heating system.

This provides better uniformity of the heating.

Advantageously, said dipping solution also comprises additives.

According to one aspect of the presently disclosed embodiment, said additives are deposited on the surface of the object during said dipping step.

This gives the surface of the object additional properties.

According to one aspect of the presently disclosed embodiment, said process is applied to an object resulting from additive manufacture techniques.

According to one aspect of the presently disclosed embodiment, said process is applied to an object made of polyamide.

### BRIEF DESCRIPTION OF THE DRAWINGS

The presently disclosed embodiment will be understood more clearly by means of the description, given hereinafter purely by way of explanation, of an aspect of the disclosed embodiment, with reference to the FIGURE in which:

FIG. 1 shows the various steps of the process according to the presently disclosed embodiment.

### DETAILED DESCRIPTION

The presently disclosed embodiment relates to a process for surface treatment of an object, for example made of polyamide, in particular but not exclusively resulting from additive manufacture techniques.

The process according to the presently disclosed embodiment comprises the following steps:
dipping the object in a solution comprising a concentrated acid or a mixture of concentrated acids, and having a pH of between 0 and 2, in order to impregnate the surface of said object;
removing the object from said acid solution;
heating the object at a temperature of between 140° C. and 180° C., until melting of the surface is obtained; and
cooling the object.

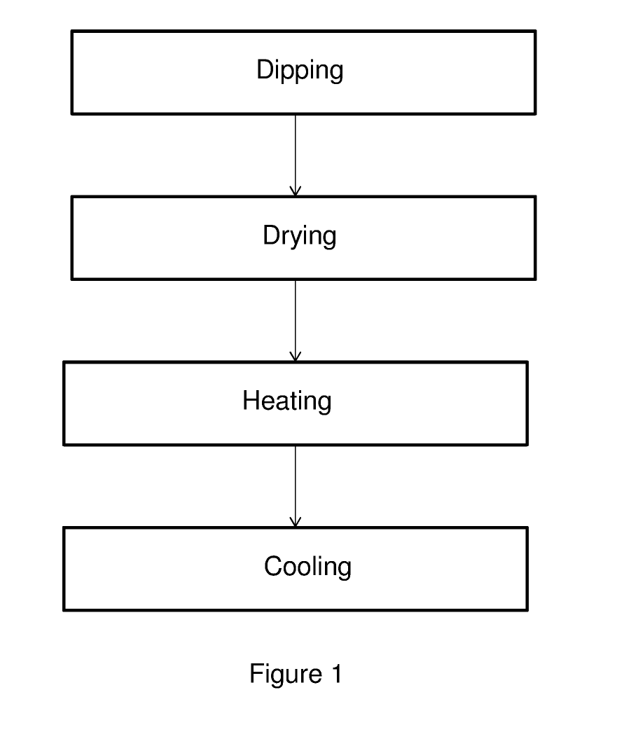

FIG. 1 shows the various steps of the process according to the presently disclosed embodiment: dipping, drying, heating and cooling, these various steps relating to the object, which, in one aspect of the presently disclosed embodiment, results from additive manufacture techniques.

In one aspect of the presently disclosed embodiment, said process is applied to an object made of polyamide.

In one aspect of the presently disclosed embodiment, the acid solution has a pH of between 0 and 1.

In one aspect of the presently disclosed embodiment, the acid is a mineral acid, and, in one aspect, the acid is included in the following group: sulphuric acid, nitric acid, phosphoric acid and hydrochloric acid.

In one aspect of the presently disclosed embodiment, the heating of the object is carried out at a temperature of between 155° C. and 170° C.

In one aspect of the presently disclosed embodiment, the process according to the disclosed embodiment also comprises a step of removing the surplus liquid. According to one variant, the removing of the surplus liquid is carried out by applying a centrifugal force to the object, and according to another variant, the removing of the surplus liquid is carried out by causing the object to vibrate.

In one aspect of the presently disclosed embodiment, the heating step is carried out using a forced convection heating system, this providing better uniformity of the heating.

In one aspect of the presently disclosed embodiment, the dipping solution also comprises additives, and according to one aspect of the disclosed embodiment, the additives are deposited on the surface of the object during the dipping step, this giving the surface of the object additional properties.

The presently disclosed embodiment is described in the aforementioned by way of example. It is understood that those skilled in the art are able to produce different variants of the presently disclosed embodiment without however departing from the context of the patent.

What is claimed is:

1. A process for surface treatment of an object, comprising the following steps:
dipping said object in a solution comprising a concentrated acid or a mixture of concentrated acids, and having a pH of between 0 and 2, in order to impregnate the surface of said object;
removing said object from said acid solution;
heating said object to a temperature of between 140° C. and 180° C., until melting of the surface is obtained; and
cooling said object.

2. The process for surface treatment of an object according to claim 1, wherein said acid solution has a pH of between 0 and 1.

3. The process for surface treatment of an object according to claim 1, wherein said acid is a mineral acid.

4. The process for surface treatment of an object according to claim 1, wherein said acid is included in the following group: sulphuric acid, nitric acid, phosphoric acid and hydrochloric acid.

5. The process for surface treatment of an object according to claim 1, wherein the heating of said object is carried out at a temperature of between 155° C. and 170° C.

6. The process for surface treatment of an object according to claim 1, characterized in that it also comprises a step of removing the surplus liquid.

7. The process for surface treatment of an object according to claim 6, wherein the removing of the surplus liquid is carried out by applying a centrifugal force to said object.

8. The process for surface treatment of an object according to claim 6, wherein the removing of the surplus liquid is carried out by causing said object to vibrate.

9. The process for surface treatment of an object according to claim 1, wherein said heating step is carried out using a forced convection heating system. The process for surface treatment of an object according to claim 1, wherein said dipping solution also comprises additives.

11. The process for surface treatment of an object according to claim 10, wherein said additives are deposited on the surface of the object during said dipping step.

12. The process for surface treatment of an object according to claim 1, wherein it is applied to an object resulting from additive manufacture techniques.

13. The process for surface treatment of an object according to claim 1, wherein it is applied to an object made of polyamide.
